(19) United States
(12) Patent Application Publication
(10) Pub. No.: US 2017/0316494 A1
(43) Pub. Date: Nov. 2, 2017

(54) PROVIDING AN INDICATION OF AUCTION BIDDING INTEREST

(71) Applicants: Douglas A. Brenhouse, Belmont, MA (US); Jeremy J. Paradise, Boston, MA (US); Andrew Kwasik, Boston, MA (US)

(72) Inventors: Douglas A. Brenhouse, Belmont, MA (US); Jeremy J. Paradise, Boston, MA (US); Andrew Kwasik, Boston, MA (US)

(21) Appl. No.: 15/139,601

(22) Filed: Apr. 27, 2016

(51) Int. Cl. G06Q 30/08; H04M 19/04; H04M 1/725

(52) U.S. Cl. CPC G06Q 30/08; H04M 1/7253; H04M 19/047

(57) ABSTRACT

Systems and methods are provided for providing an indication of auction bidding interest. In general, an auction system can be configured to provide an auctioneer of a live auction with a notification of bidding interest prior to a bid being made. A notification of bidding interest prior to a bid being made can be provided to an auctioneer of a live auction in any of a variety of ways. In one embodiment, the notification can include at least one of a visual, an auditory, and a haptic signal directed to the auctioneer.

### FIELD

The present disclosure relates generally to providing an indication of auction bidding interest.

### BACKGROUND

Auction houses providing live auctions traditionally allow bidders to place live auction bids either in person or from remote locations, such as by telephone. An auctioneer of a live auction must therefore be aware of both incoming bids made by bidders who are on site with the auctioneer and incoming bids made by remote bidders who are off site from the auctioneer. The auctioneer can visually see onsite bidders and can thus gauge onsite bidding interest in an auction lot by visually observing the activity of potential bidders. The auctioneer cannot, however, see offsite bidders and therefore cannot gauge bidding interest of these bidders on the auction lot. Without being able to gauge overall bidding interest in an auction lot from both onsite and offsite bidders, an auctioneer may close bidding prematurely and thus not achieve the highest possible price for the auction lot and/or the auctioneer may not be able to properly time the use of their learned skills of selling and persuasion to effectively elicit bids.

Further, as telephones and networking technology have made live auctions more easily accessible to a global audience without any meaningful time lag, fewer bidders are on site live with auctioneers than in years past. Auctioneers thus has even less ability to gauge overall bidding interest in an auction lot when multiple bidders are offsite. In at least some cases, the majority of bidders are offsite, further degrading the auctioneer's ability to gauge overall bidding interest.

Accordingly, a need exists for improved systems and methods for providing an indication of auction bidding interest.

### SUMMARY

Systems and methods for providing an indication of auction bidding interest are provided.

In one aspect, an auction system is provided that in one embodiment includes a first client terminal and a second client terminal. The first client terminal includes a first display, a first memory storing first instructions, and a first processor. The first processor is configured to execute the stored first instructions to cause first information regarding an auction lot available for live auction bidding to be shown on the first display, and to receive a first signal indicative of a first input to the first client terminal. The first input is indicative of an interest of a first user to enter a bid on the auction lot. The first processor is configured to, in response to the receipt of the first input, cause the first display to show second information allowing the first user to enter the bid on the auction lot. The second client terminal includes a second processor, a second display, and a second memory storing second instructions. The second processor is configured to execute the stored second instructions to cause third information regarding the auction lot available for live auction bidding to be shown on the second display. The first processor is configured to, in response to the receipt of the first input, cause a second signal to be transmitted to the second client terminal. The second processor is configured to, in response to the receipt of the second signal, cause a notification to be provided to a user of the second client terminal.

The system can have any number of variations. For example, the first processor can be configured to cause the second signal to be transmitted to the second client terminal whether or not the first user enters the bid on the auction lot. For another example, the notification can include at least one of a visual notice shown on the second display, an audible sound provided through the second client terminal, and a haptic signal. For yet another example, the first processor can be configured to receive a third signal indicative of a second input to the first client terminal, the second input can be indicative of the user entering the bid on the auction lot, and, in response to the receipt of the third signal, the processor can be configured to cause a fourth signal to be transmitted to the second client terminal that is indicative of the entered bid. For still another example, the second processor can be configured to cause a third signal to be transmitted from the second client terminal to the first client terminal, the third signal can be indicative of the first information, and the first processor can be configured to, in response to receipt of the third signal at the first client terminal, cause the first information to be shown on the first display. For another example, the first client terminal can include an input/output device configured to receive the first input thereto and to transmit the first signal to the first processor. For yet another example, the first client terminal can include a first network interface configured to facilitate electronic communication over a network, and the second client terminal can include a second network interface configured to facilitate electronic communication over the network. For another example, the first client terminal can include one of a desktop computer, a workstation, a minicomputer, a laptop computer, a tablet computer, a personal digital assistant (PDAs), a smart mobile phone, and a smart watch. For still another example, the second client terminal can include one of a desktop computer, a workstation, a minicomputer, a laptop computer, a tablet computer, a personal digital assistant (PDAs), a smart mobile phone, and a smart watch.

For another example, the system can include a plurality of additional client terminals. Each of the plurality of additional client terminals can be configured to cause information regarding the auction lot available for live auction bidding to be shown on a display associated with the client terminal, and to receive a signal indicative of an input to the client terminal. The input can be indicative of an interest of a user to enter a bid on the auction lot. Each of the plurality of additional client terminals can be configured to, in response to the receipt of the input, cause a signal to be transmitted to the second client terminal. The second processor can be configured to, in response to the receipt of signal from the client terminal, cause a notification to be provided to the user of the second client terminal such that the user of the second client terminal can receive a plurality of notifications from any two or more of the first client terminal and the plurality of additional client terminals.

In another embodiment, an auction system includes a master client terminal including a display, a memory storing instructions, and a processor. The processor is configured to execute the stored instructions to cause information regarding an auction lot available for live auction bidding to be shown on the display, and, for each of a plurality of client terminals that are each remotely located from the master client terminal and that are each associated with a unique bidder, either receive no signal therefrom so as to indicate no interest in bidding on the auction lot from the bidder or receive a first signal therefrom so as to indicate interest in bidding on the auction lot from the bidder. The processor is configured to, for each of the one or more of the plurality of client terminals that transmit the first signal to the master client terminal, either receive no follow-up signal therefrom so as to indicate no bid being placed by the bidder on the auction lot or receive a second signal therefrom so as to indicate a bid being placed by the bidder on the auction lot. The processor is configured to, in response to the receipt of each of the first signals, cause a notification to be provided to a user of the master client terminal.

The system can vary in any number of ways. For example, the master client terminal can receive the first signal whether or not the bidder bids on the auction lot. For another example, the notification can include at least one of a visual notice shown on the display, an audible sound provided through the client terminal, and a haptic signal. For yet another example, the user of the master client terminal can be an auctioneer. For still another example, the master client terminal can include one of a desktop computer, a workstation, a minicomputer, a laptop computer, a tablet computer, a personal digital assistant (PDAs), a smart mobile phone, and a smart watch. For another example, the plurality of client terminals can each be selected from the group consisting of a desktop computer, a workstation, a minicomputer, a laptop computer, a tablet computer, a personal digital assistant (PDAs), a smart mobile phone, and a smart watch.

In another aspect, an auction method is provided that in one embodiment includes causing information regarding an auction lot available for live auction bidding to be shown on a display of a master client terminal. The display is visually observable to an auctioneer of the live auction. The method also includes, for each of a plurality of bidders that are each remotely located from the auctioneer, the master client terminal either (a) receiving no signal from a client terminal associated with the bidder so as to indicate no interest in bidding on the auction lot from the bidder or (b) receiving a first signal from the client terminal associated with the bidder so as to indicate interest in bidding on the auction lot from the bidder. The method also includes, for each of the one or more of the client terminals that transmit the first signal to the master client terminal, either (c) receiving no follow-up signal from the client terminal associated with the bidder so as to indicate no bid being placed by the bidder on the auction lot or (d) receiving a second signal from the client terminal associated with the bidder so as to indicate a bid being placed by the bidder on the auction lot. The method also includes, in response to the receipt of each of the first signals, causing a notification to be provided to the auctioneer.

The method can vary in any number of ways. For example, the master client terminal can receive the first signal whether or not the bidder bids on the auction lot. For another example, the notification can include at least one of a visual notice shown on the display, an audible sound provided through the client terminal, and a haptic signal. For yet another example, the master client terminal can include one of a desktop computer, a workstation, a minicomputer, a laptop computer, a tablet computer, a personal digital assistant (PDAs), a smart mobile phone, and a smart watch.

Non-transitory computer program products (i.e., physically embodied computer program products) are also provided that store instructions, which when executed by one or more processors of one or more computer systems, causes at least one processor to perform operations herein. Similarly, computer systems are also provided that can include one or more processors and one or more memories coupled to the one or more processors. Each of the one or more memories can temporarily or permanently store instructions that cause at least one processor to perform one or more of the operations described herein. In addition, methods can be implemented by one or more processors either within a single computer system or distributed among two or more computer systems. Such computer systems can be connected and can exchange data and/or commands or other instructions or the like via one or more connections, including but not limited to a connection over a network (e.g., the Internet, a wireless wide area network, a local area network, a wide area network, a wired network, etc.), via a direct connection between one or more of the multiple computer systems, etc.

### BRIEF DESCRIPTION OF DRAWINGS

This invention will be more fully understood from the following detailed description taken in conjunction with the accompanying drawings, in which:

FIG. 1 is a schematic diagram of one embodiment of a computer system;

FIG. 2 is a schematic diagram of one embodiment of an auction system;

FIG. 3 is a diagram of one embodiment of an auction information screen;

FIG. 4 is a diagram of one embodiment of an auction bid screen;

FIG. 5 is a diagram of one embodiment of an auction lot information screen; and

FIG. 6 is a flowchart of one embodiment of a live auction bidding process for an auction lot.

### DETAILED DESCRIPTION

Certain exemplary embodiments will now be described to provide an overall understanding of the principles of the structure, function, manufacture, and use of the devices and methods described herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon.

Systems and methods are provided for providing an indication of auction bidding interest. In general, an auction system can be configured to provide an auctioneer of a live auction with a notification of bidding interest prior to a bid being made. The auctioneer may thus avoid prematurely closing an auction lot before all interested bidders have made a bid and thereby help obtain maximum bid amount and/or help meet an auction's reserve price, the auctioneer may be incited to increase their efforts to elicit bids through, e.g., verbal persuasion, emphatic gestures, etc., since interest is known to exist but has not yet resulted in a formal bid, and/or the auctioneer can receive a verified signal of bidder interest instead of having to rely on the auctioneer's powers of observation, which may become strained during the frenzy of a live auction and/or be undeveloped as a skill in the case of less experienced auctioneers.

Traditional live auctions operate on a binary bidding system where either a bid exists (yes, a bid has been made) or a bid does not exist (no, a bid has not been made). Thus, while an auctioneer may have some information regarding bid interest in an auction lot based on the frequency at which bids are being made, based on bid increments, and/or based on the auctioneer's visual observation of activity of onsite bidders (e.g., bidders in the same room or other physical location as the auctioneer), the auctioneer is unable to visually observe offsite bidders (e.g., bidders bidding over a network such as the Internet). The auctioneer thus necessarily has limited bidding interest information for any auction lot having one or more offsite bidders watching or otherwise following the auction remotely (e.g., viewing or otherwise following the auction online over a network such as the Internet). Conversely, the systems and methods described herein can provide a 3-way bidding system where a bid exists (e.g., bid=yes), a bid does not exist (e.g., bid=no), or interest in a bid exists (e.g., bid=maybe). An auctioneer of a live auction can thus have more bidding interest information than in traditional live auctions where bidding interest of offsite bidders cannot be assessed visually or otherwise by the auctioneer until an offsite bidder has entered a formal bid. The auctioneer may thus avoid prematurely closing an auction lot before all interested bidders have made a bid and thereby help obtain maximum bid amount and/or help meet an auction's minimum acceptable bid, the auctioneer may be incited to increase their efforts to elicit bids since interest is known to exist but has not yet resulted in a formal bid, and/or the auctioneer can receive a verified signal of bidder interest instead of having to rely on the auctioneer's skills of observation, which may take time and experience to develop.

A notification of bidding interest prior to a bid being made can be provided to an auctioneer of a live auction in any of a variety of ways. In an exemplary embodiment, the notification can include at least one of a visual signal, an auditory signal, and a haptic signal directed to the auctioneer. For example, the notification can include a visual signal in the form of an icon, symbol, text, and/or other visible information on a display screen on which the auctioneer is receiving information regarding an auction lot. In many modern live auctions, auctioneers have a display screen (e.g., a display of a desktop computer, a display of a laptop computer, a display of a tablet computer, a display of a smart phone, a TV monitor, etc.) on which information regarding at least the current auction lot is available, such as auction lot identifier (e.g., number, letter, code, etc.), starting bid price, current bid price, auction lot description, identity of seller or consigner, etc. The notification can be integrated onto this display screen such that an auctioneer's traditional display screen including auction information can be upgraded or otherwise retrofitted to include the notification. Even if an auctioneer does not currently use a display screen as part of his/her live auction process, a display screen can be easily incorporated into the auctioneer's live auction process (e.g., by the auctioneer holding a smart phone, having a display screen mounted on a podium at which the auctioneer is standing, etc.) so as to allow the visual notification to be provided to the auctioneer via display screen.

For another example, the notification can include an audible sound such as a beep, a series of beeps, a spoken word announcement, and/or other sound directed to the auctioneer. The audible sound can be directed to the auctioneer by, for example, being provided through an earpiece or through headphones worn by the auctioneer, which may allow the sound to be heard by the auctioneer but not by others and thus not be a distraction to others and/or not provide undue advantage to bidders within earshot of the audible sound.

For yet another example, the notification can include a haptic signal such as a vibration, e.g., a vibration of a smart phone using the phone's built-in vibration feature, or an electronic “tap” or “ping,” e.g., a tap on a wrist using a smart watch's (such as an Apple Watch's) built-in haptic features. The haptic signal may be more noticeable to an auctioneer than a visual notification or an audible notification since it need not rely on a quiet enough environment for detection (unlike an audible sound) and need not rely on the auctioneer's eye being directed to a certain place (unlike a visual signal). In at least some embodiments, the haptic signal can be provided to an auctioneer via a client terminal associated with the auctioneer and that the auctioneer is using to generally track bids and receive information about the auction lot (e.g., current bid, auction lot description, etc.), such as by the client terminal vibrating. In at least some embodiments, the haptic signal can be provided to an auctioneer via a device other than a client terminal associated with the auctioneer and that the auctioneer is using to generally track bids and receive information about the auction lot, such as via a second client terminal. The second client terminal can, in at least some embodiments, include a wearable device worn by the auctioneer. Embodiments of wearable devices configured to provide a haptic signal to an auctioneer are further described in U.S. patent application Ser. No. ______ entitled “Auction Bid Notification Via A Wearable Device” filed on even date herewith [Attorney Docket No. 43115-506F01US].

A combination of two or more of visual, auditory, and haptic signals may help ensure that an auctioneer receives the notification of bid interest than if only one of the types of signals is provided to the auctioneer.

A bidder, e.g., an offsite bidder, can trigger the notification to be provided to the auctioneer. The notification process can be invisible to the bidder. The bidder's bidding process thus can remain uninterrupted from the bidder's perspective, which may help preserve auction flow and/or prevent bidder distraction from bid-making. The notification can be configured to be automatically provided to the auctioneer in response to the occurrence of a predetermined bidder action. In an exemplary embodiment, the predetermined bidder action can include selection by a bidder of a predetermined selector on an offsite bidding tool such as a graphical user interface (GUI) on a tablet computer or other computer system associated with the bidder. The predetermined selector can include a feature of the offsite bidding tool configured to trigger bid entry by the bidder. For example, the predetermined selector can include a clickable button, a slidable bar, an icon, a symbol, text, and/or other item configured to be selectable by the bidder (or other user acting on behalf of the bidder) to indicate that a bid amount is about to be entered. The auctioneer may thus receive an indication of the bidder's interest in bidding prior to a bid being formally made. Following selection of the selector, a bid amount may not end up being submitted by the bidder (or user acting on behalf of the bidder) for any one or more reasons, such as the current bid increasing beyond the bidder's comfort level before the bidder (or user acting on behalf of the bidder) submits the bid amount, the bidder (or user acting on behalf of the bidder) having accidentally selected the selector, etc., but the auctioneer receiving the notification in response to selection of the selector may still provide one or more benefits, such as the auctioneer keeping bidding open on the auction lot in response to receipt of the notification during which open time another bidder makes a bid that may not have otherwise been made had the auction not been kept open.

The systems and methods described herein can be used in connection with a live auction auctioning any one or more types of goods and/or services. For example, the live auctions can include auctions for art, real estate, collectibles, cars, boats, livestock, coins and currencies, antiquities, maps, books, posters, entertainment memorabilia, record albums and other types of music, musical instruments, electronics, clothing, jewelry, furniture, glassware, tableware, fine metals, and/or wine.

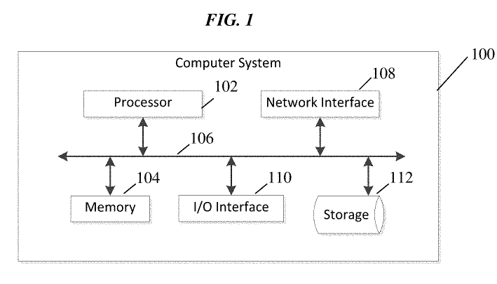

The systems and methods disclosed herein can be implemented using one or more computer systems. FIG. 1 illustrates one exemplary embodiment of a computer system 100. As shown, the computer system 100 can include one or more processors 102 which can control the operation of the computer system 100. The processor(s) 102 can include any type of microprocessor or central processing unit (CPU), including programmable general-purpose or special-purpose microprocessors and/or any one of a variety of proprietary or commercially available single or multi-processor systems. The computer system 100 can also include one or more memories 104, which can provide temporary storage for code to be executed by the processor(s) 102 or for data acquired from one or more users, storage devices, and/or databases. The memory 104 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 100 can be coupled to a bus system 106. The illustrated bus system 106 is an abstraction that represents any one or more separate physical busses, communication lines/interfaces, and/or multi-drop or point-to-point connections, connected by appropriate bridges, adapters, and/or controllers. The computer system 100 can also include one or more network interface(s) 108, one or more input/output (I/O) interface(s) 110, and one or more storage device(s) 112.

The network interface(s) 108 can enable the computer system 100 to communicate with remote devices, e.g., other computer systems, over a network, and can be, for example, remote desktop connection interfaces, Ethernet adapters, and/or other local area network (LAN) adapters. The I/O interface(s) 110 can include one or more interface components to connect the computer system 100 with other electronic equipment. For example, the I/O interface(s) 110 can include high speed data ports, such as USB ports, 1394 ports, Wi-Fi, Bluetooth, etc. Additionally, the computer system 100 can be accessible to a human user, and thus the I/O interface(s) 110 can include displays, speakers, keyboards, pointing devices, and/or various other video, audio, or alphanumeric interfaces. The storage device(s) 112 can include any conventional medium for storing data in a non-volatile and/or non-transient manner. The storage device(s) 112 can thus include a memory that holds data and/or instructions in a persistent state, i.e., the value is retained despite interruption of power to the computer system 100. The storage device(s) 112 can include one or more hard disk drives, flash drives, USB drives, optical drives, various media cards, diskettes, compact discs, and/or any combination thereof and can be directly connected to the computer system 100 or remotely connected thereto, such as over a network. In an exemplary embodiment, the storage device(s) can include a tangible or non-transitory computer readable medium configured to store data, e.g., a hard disk drive, a flash drive, a USB drive, an optical drive, a media card, a diskette, a compact disc, etc.

The elements illustrated in FIG. 1 can be some or all of the elements of a single physical machine. In addition, not all of the illustrated elements need to be located on or in the same physical machine, at least in the case of external electronic devices. Exemplary computer systems include conventional desktop computers, workstations, minicomputers, laptop computers, tablet computers, personal digital assistants (PDAs), smart mobile phones, smart watches, and the like.

The computer system 100 can include a web browser for retrieving web pages or other markup language streams, presenting those pages and/or streams (visually, aurally, or otherwise), executing scripts, controls and other code on those pages/streams, accepting user input with respect to those pages/streams (e.g., for purposes of completing input fields), issuing Hypertext Transfer Protocol (HTTP) requests with respect to those pages/streams or otherwise (e.g., for submitting to a server information from the completed input fields), and so forth. The web pages or other markup language can be in HyperText Markup Language (HTML) or other conventional forms, including embedded Extensible Markup Language (XML), scripts, controls, and so forth. The computer system 100 can also include a web server for generating and/or delivering the web pages to client computer systems.

In an exemplary embodiment, the computer system 100 can be provided as a single unit, e.g., as a single server, as a single tower, contained within a single housing, etc. Systems and methods can thus be provided as a singular unit configured to display the various user interfaces and capture the data described herein. The singular unit can be modular such that various aspects thereof can be swapped in and out as needed for, e.g., upgrade, replacement, maintenance, etc., without interrupting functionality of any other aspects of the system. The singular unit can thus also be scalable with the ability to be added to as additional functionality is desired and/or improved upon.

While some embodiments are described herein in the context of web pages, it will be appreciated that in other embodiments, one or more of the described functions can be performed without the use of web pages and/or by other than web browser software. A computer system can also include any of a variety of other software and/or hardware components, including by way of example, operating systems and database management systems. Although an exemplary computer system is depicted and described herein, it will be appreciated that this is for sake of generality and convenience. In other embodiments, the computer system may differ in architecture and operation from that shown and described here.

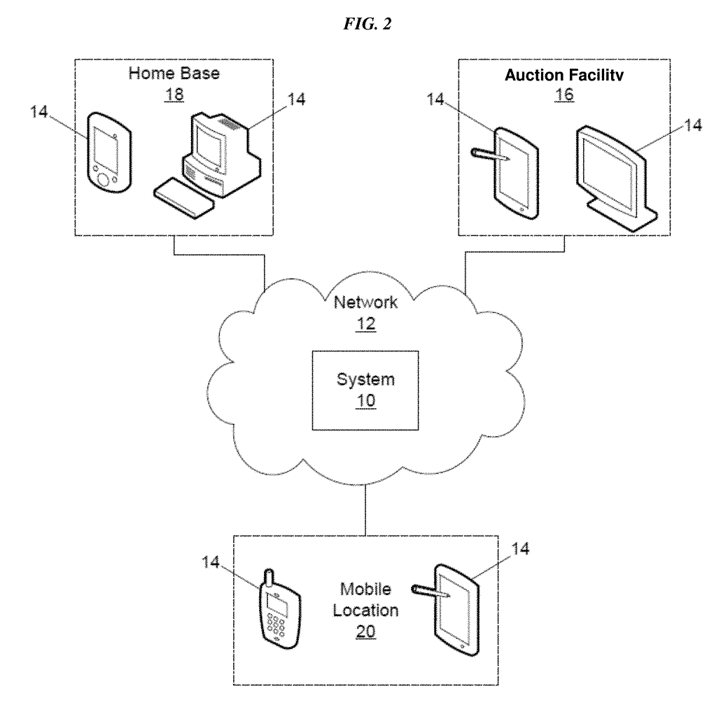

FIG. 2 is a schematic block diagram of one exemplary embodiment of an auction system 10. The system 10 can be implemented using one or more computer systems of the type described above, and in particular using one or more web pages which can be viewed, manipulated, and/or interacted with using such computer systems. The system 10 can thus be implemented on a single computer system, or can be distributed across a plurality of computer systems. The system 10 can include one or more databases, which can be stored on and accessed by computer systems.

Any of a variety of users can access, interact with, control, etc. the auction system 10 from any of a variety of locations. For example, as shown in the embodiment illustrated in FIG. 2, the auction system 10 can be accessible over a network 12 (e.g., over the Internet via cloud computing) from any number of client stations 14 in any number of locations such as an auction facility 16 (e.g., a site such as an auction house where a live auction is occurring, etc.), a home base 18 (e.g., an auction bidder's home or office), a mobile location 20, and so forth. The system 10 is shown in this illustrated embodiment as being at a separate location from the auction facility 16, but in some embodiments, the system 10 can be located at the auction facility 16. The client station(s) 14 can access the system 10 through a wired and/or wireless connection to the network 12. In an exemplary embodiment, at least some of the client terminal(s) 14 can access the system 10 wirelessly, e.g., through Wi-Fi connection(s), which can facilitate accessibility of the system 10 from almost any location in the world. As shown in FIG. 2, the auction facility 16 includes client stations 14 in the form of a tablet and a computer touch screen, the home base 18 includes client stations 14 in the form of a mobile phone having a touch screen and a desktop computer, and the mobile location 20 includes client stations 14 in the form of a tablet and a mobile phone, but the auction facility 16, the home base 18, and the mobile location 20 can include any number and any type of client stations. In an exemplary embodiment, the system 10 can be accessible by a client terminal via a web address and/or a client application (generally referred to as an “app”).

It will be appreciated that the system 10 can include security features such that the aspects of the system available to any particular user can be determined based on the identity of the user and/or the location from which the user is accessing the system. To that end, each user can have a unique username, password, and/or other security credentials to facilitate access to the system 10. The received security parameter information can be checked against a database of authorized users to determine whether the user is authorized and to what extent the user is permitted to interact with the system, view information stored in the system, and so forth. Exemplary examples of users who can be permitted to access the system 10 include potential auction bidders, auctioneers, and auction house administrators.

Data related to the systems and methods described herein can be displayed in a variety of ways. The data can be displayed via a GUI or display screen of a computer system. The screen can show a variety of different types of information, and the information can be displayed in any of a variety of ways.

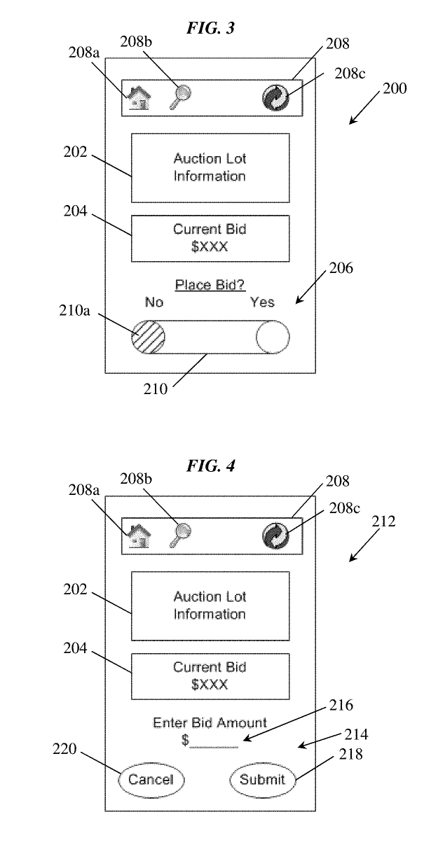

FIGS. 3-5 illustrate embodiments of screens including data related to live auction bidding that can each be configured to be provided by an auction system. The information shown on these screens are examples only, and any of the screens can include more information or less information. The screens discussed below with respect to FIGS. 3-5 are touch screens, but similar screens can be provided on other types of displays. The screens of FIGS. 3-5 are examples only and can show a variety of different types of information, and the information can be displayed in any of a variety of ways.

FIG. 3 illustrates an embodiment of an auction information screen 200 configured to display information regarding a live auction to a bidder. (The term “bidder” is used herein to refer to users who have actually placed bids in an auction as well as to users who may place a bid in the auction but who may or may not end up doing so in the course of the auction.) The auction information screen 200 can be configured to be displayed on a display of a client terminal, e.g., computer system, associated with the bidder (or a user authorized to bid on behalf of the bidder). As mentioned above, the bidder (or the user authorized to bid on behalf of the bidder) can be required to login to verify identity and/or location prior to being given access to the auction information screen 200. The auction information screen 200 can be configured to be displayed on the display of the bidder's associated computer system via web address so as to be shown on the display as a web page or via a program or an app installed on the computer system.

As in this illustrated embodiment, the auction information screen 200 can include auction lot information 202, current bid information 204, a selector 206, and a menu 208. The auction lot information 202 can include data regarding the current auction lot available for bids, such as auction lot identifier, starting bid price, auction lot description, image of the auctioned good(s), name and/or logo of the auction house offering the auction lot, etc. The auction lot information 202 can be configured to automatically update in real time to reflect the currently active auction lot, e.g., the auction lot that is currently open and accepting bids or, in the case of no auction lot being currently active, the next auction lot that will be opened for bidding.

The current bid information 204 can show the current bid price for the auction lot identified by the auction lot information 202. If no auction lot is currently active, the current bid information 204 may be absent from the screen 200, may show “none,” “not applicable,” or other appropriate message, or may be dimmed or otherwise indicated as being inactive due to not auction lots currently being open for bidding. The current bid information 204 in this illustrated example is shown in dollars, but any other currency can be shown instead or in addition.

The menu 208 can include one or more options selectable by a user (e.g., by the bidder or a user authorized to bid on behalf of the bidder) to access information other than that shown on the auction information screen 200. The menu 208 can include any number of options, which in this illustrated embodiment include selectable icons. In this illustrated embodiment, the selectable icons include a home icon 208a configured to, upon selection, display a home page on the display screen, a search icon 208b configured to, upon selection, allow the bidder (or user authorized to bid on behalf of the bidder) to search auction lots offered in the auction), and a refresh icon 208c configured to, upon selection, manually refresh the auction information page 200. The auction information page 200 can, as will be appreciated, be configured to automatically refresh on a predetermined schedule. The bidder (or user authorized to bid on behalf of the bidder) may, however, desire to refresh more frequently.

The selector 206 can be configured to be selectable by the bidder (or the user authorized to bid on behalf of the bidder) to start a bid entry process for the currently active auction lot. The selector 206 can be configured as the predetermined selector discussed above. In other words, the selector 206 can be configured to be selectable by a user, either the bidder or a user authorized to bid on behalf of the bidder, to indicate that a bid amount may be about to be entered. In this illustrated embodiment, the selector 206 includes a slidable bar 210 configured to be activated by the bidder (or the user authorized to bid on behalf of the bidder) by sliding a bar marker 210a along the slidable bar 210 from “Place Bid? No” to “Place Bid? Yes,” such as through a finger sliding along the bar 210 on the touch screen. The bar marker 210a can be defaulted to “Place Bid? No” on the auction information screen 200, thereby requiring the bidder (or user authorized to bid on behalf of the bidder) to perform an action to begin the bid entry process. The selector 206 can thus be configured to serve as a safety feature to help ensure that bids are not accidentally entered. In other words, by requiring the user to perform an action to begin the bid entry process, bids are less likely to be accidentally submitted. As mentioned above, the selector 206 can have other configurations. For example, the text “No” and “Yes” can be configured to be activated by touch, with “No” being the default selection on the screen 200 until, and if, the bidder or the user authorized to bid on behalf of the bidder) selected “Yes,” such as by touching the word “Yes” on the touch screen. The slidable bar 210 and bar marker 201a can thus be absent from the screen 200. For another example, a selectable button can be adjacent each of the text “No” and “Yes.” The slidable bar 210 and bar marker 201a can thus be absent from the screen 200.

Activation of the selector 206, e.g., indicating “Yes” in response to the “Place Bid?” question by sliding the bar marker 210a to the right side of the bar 210,” can be configured to automatically trigger a real time notification to be provided to the auctioneer indicative of interest in bidding on the current auction lot. The client terminal associated with the display showing the auction information screen 200, e.g., a tablet computer having a display screen showing the auction information screen 200, a desktop computer showing the auction information screen 200 on a monitor, a smart phone having a display screen showing the auction information screen 200, etc. can be configured to transmit a signal to client terminal associated with the auction provider. The client terminal associated with the auction provider can include a client terminal being used by the auctioneer such that the bidder's associated client terminal directly transmits a signal to the auctioneer's client terminal over a network without receipt by any intervening client terminals. In another embodiment, the bidder's associated client terminal can be configured to transmit a signal to a client terminal associated with the auction provider, e.g., the auction house providing the auction, which can be configured to transmit the received signal to the auctioneer's associated client terminal. The auction provider's associated client terminal can thus be configured as a clearinghouse for the auctioneer's associated client terminal. The auction provider's associated client terminal receiving the signal prior to the auctioneer's associated client terminal receiving the signal may help preserve bidder anonymity to the auctioneer, may allow bid interest to be authenticated as being from an authorized bidder by the clearinghouse before being provided to the auctioneer as an accurate indication of real interest from a real bidder in the current auction lot, and/or may allow the clearinghouse to store records regarding received bid interest from offsite bidders to help analyze auction habits of bidders after the auction to help organize, advertise, and/or maximize effectiveness of future auctions.

The notification provided to the auctioneer can uniquely identify the bidder to the auctioneer in an anonymous manner (e.g., identifying the bidder by identification code that the auctioneer cannot use during the bidding on the auction to ascertain the identity of the bidder) or in a non-anonymous manner (e.g., identifying the bidder by name or in another way in which the auctioneer can ascertain the identity of the bidder during the bidding on the auction). In an exemplary embodiment, the notification can be anonymous, which may help maintain auctioneer neutrality and/or serve bidder privacy.

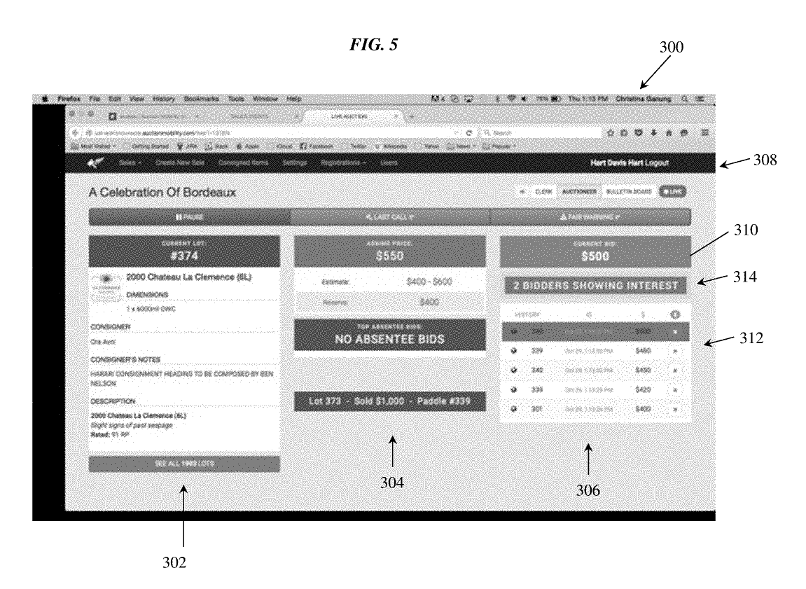

Activation of the selector 206, e.g., indicating “Yes” in response to the “Place Bid?” question by sliding the bar marker 210a to the right side of the bar 210,” can be configured to trigger bid entry by the bidder (or the user authorized to bid on behalf of the bidder). To facilitate the bid entry, the activation of the selector 206 can cause an auction bid screen 212 to be displayed on the display, as shown in FIG. 4. In general, the auction bid screen 212 can be configured to allow the bidder (or the user authorized to bid on behalf of the bidder) to submit a bid for the current auction lot. The auction bid screen 212 can include the auction lot information 202, the current bid information 204, the menu 208, and a bid entry portion 214. The bid entry portion 214 can be configured to allow the bidder (or the user authorized to bid on behalf of the bidder) to enter a bid amount in a provided space 216, e.g., by typing numbers on a keyboard of the bidder's associated client terminal, by using voice command functionality of the bidder's associated client terminal, etc. The entered bid may then be formally submitted as a bid by selecting a submit icon 218. The display may then return to showing the auction information screen 200. The bidder (or the user authorized to bid on behalf of the bidder) may thus continue monitoring the auction of the current auction lot and may submit one or more additional bids if desired based on changes in the current auction price reflective of the bidder not being the current high bidder.

Alternatively, instead of submitting a bid via the auction bid screen 212, the bidder (or the user authorized to bid on behalf of the bidder) can exit the auction bid screen 212 without submitting a bid (with or without having entered a bid amount into the provided space 216) by selecting a cancel icon 220. The submit and cancel icons 218, 220 in this illustrated embodiment include selectable oval-shaped buttons, but submission and cancellation functionality can be provided on the auction bid screen 212 in any of a number of other ways, such as by being selectable symbols, selectable text, etc.

Thus, regardless of whether or not the bidder (or the user authorized to bid on behalf of the bidder) submits a bid for the current auction lot via the auction bid screen 212, the auctioneer has received notification of the bidder's interest in bidding on the current auction lot due to the selection of the selector 206 on the auction information screen 200. If the bidder (or the user authorized to bid on behalf of the bidder) does not submit a bid right away, the auctioneer has knowledge of bidding interest in the current auction lot due to the activation of the selector 206 and may thus, as discussed above, keep the auction lot open for bidding and/or persuasively urge bidding on the auction lot. The bidder may thus be able to submit a bid when, absent the notification to the auctioneer, the bid may not have been able to be made due to the auctioneer closing the auction before bid submission. If the bidder (or the user authorized to bid on behalf of the bidder) does not submit a bid at all on the via bid screen 212 and instead, for example, returns to the auction information screen 200 via the cancel icon 220 or closes the auction system web page or app, the auction may still benefit from the activation of the selector 206, as discussed above, such as by resulting in one or more bids being made by one or more other bidders who may not have otherwise made any bids but for the auctioneer keeping the auction lot open and/or the auctioneer's persuasive urging for bidding on the auction lot.

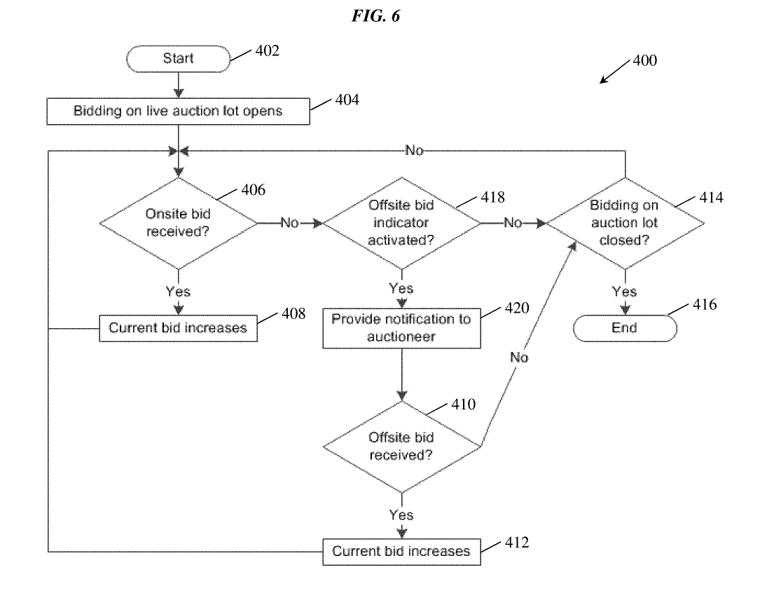

FIG. 5 illustrates an embodiment of an auction lot information screen 300 configured to display information regarding an auction lot of live auction to an auctioneer. The auction lot information screen 300 can be configured to be displayed on a display of a client terminal, e.g., computer system, associated with an auctioneer of a live auction. As mentioned above, the auctioneer can be required to login to verify identity and/or location prior to being given access to the auction lot information screen 300. The auction lot information screen 300 can be configured to be displayed on the display of the auctioneer's associated computer system via web address so as to be shown on the display as a web page or via a program or an app installed on the computer system.

As in this illustrated embodiment, the auction lot information screen 300 can include current (active) auction lot information 302, current lot bid information 304, current lot bid interest information 306, and a menu 308. The current auction lot information 302 can include data regarding the current auction lot available for bids, such as auction lot identifier (“#374” in this illustrated embodiment), starting bid price, auction lot description, image of the auctioned good(s), name and/or logo of the auction house offering the auction lot, name of the consigner of the auction lot, information about the auction lot from the consigner, etc.

The current lot bid information 304 can show information related to bids for the current auction lot, such as the lot's asking price, the lot's estimate, the lot's reserve price, and whether any absentee bids exist for the lot. The current lot bid information 304 can include information for any one or more other auctions, such as the immediately preceding auction (as in this illustrated embodiment), other auctions by the same consigner, and/or related lots in the auction.

The menu 308 can include one or more options selectable by a user (e.g., by the auctioneer) to access information other than that shown on the auction lot information screen 300. The menu 308 can include any number of options, which in this illustrated embodiment include selectable text of “Sales,” “Create New Sale,” “Consigned Items,” “Settings,” “Registrations,” “Users,” and “Logout.”

The current lot bid interest information 306 can include information related to bidding on the current auction lot. The current lot bid interest information 306 can include the current bid price 310 for the auction lot, can include historical bid information 312 for the item(s) in the current auction lot, and can include information 314 indicating whether any notifications have been received by the auctioneer's associated client terminal, e.g., the client terminal associated with the display showing the screen 300, indicating interest in bidding on the current auction lot. In other words, the current lot bid interest information 306 can include information related to selectors selected by bidders and those users authorized to bid on behalf of bidders. As in this illustrated embodiment, the information 314 indicating whether any notifications have been received can indicate a number of bidders having triggered notifications to be received, which is two in this illustrated embodiment. The auctioneer may thus easily determine from viewing the screen 300 that interest in the current auction lot exists and that the auction lot should perhaps not yet be closed and/or bid encouragement should be provided.

The information 314 indicating whether any notifications have been received can be in a different color than other information on the screen 300, which may help the information 314 stand out and be noticed by the auctioneer, as in this illustrated example in which the information 314 has a yellow border, where yellow is otherwise not present on the screen 300. In addition to or in alternative to the information 314 being in a different color, the information 314 and/or a mark nearby or a border therearound may flash on the screen 300, which may help the information 314 stand out and be noticed by the auctioneer. In addition to or in alternative to the information 314 being in a different color or having a flash associated therewith on the screen 300, an audible sound and/or a haptic signal may be provided to the auctioneer upon receipt of each of the notifications, as discussed above.

FIG. 6 illustrates an embodiment of a method 400 of using an auction system configured to provide an indication of auction bidding interest. The method 400 can start 402 with bidding on a live auction lot opening 404. The bidding can be opened 404 by an auctioneer in any of a variety of ways, as will be appreciated, such as by verbally announcing the opening 404 of bids on the auction lot and by electronically indicating the opening 404 of bids via a client terminal associated with the auctioneer. Onsite bidders can be made aware of the bid opening 404 in any of a variety of ways, as will be appreciated, such as by visually and/or audibly observing the auctioneer on site therewith. Offsite bidders can be made aware of the bid opening 404 in any of a variety of ways, as will be appreciated, such as by each of the bidders' associated client terminals receiving a signal from the auctioneer's associated client terminal (either directly or via a clearinghouse) indicative of bid opening 404 that causes notice of the bid opening 404 to be provided to the bidders via their respective associated client terminals.

With bids open 404 on the auction lot, the auctioneer can monitor the submission of bids by onsite bidders and bids by offsite bidders. If a bid is submitted 406 by an onsite bidder, e.g., by verbal bid and/or by raised bidding paddle, the auctioneer can accept the bid and raise 408 the current price of the auction lot in accordance with the bid and continue monitoring for the submission of bids. Similarly, if a bid is submitted 410 by an offsite bidder, e.g., by electronically submitted bid via the bidder's associated client terminal, the auctioneer can accept the bid and raise 412 the current price of the auction lot in accordance with the bid and continue monitoring for the submission of bids. Although not shown in the illustrated method 400, at least some auction lots may have one or more absentee bids associated therewith, and the auctioneer can increase the current price of the auction lot according to the absentee bid(s), as will be appreciated. If no bids have been made, or when bids have ceased being made, bidding can be closed 414 by the auctioneer, as will be appreciated, with the method 400 then ending 416. The method 400 may then repeat with one or more additional auction lots being sequentially opened for bidding.

In the method 400, prior to an offsite bidder submitting 410 a bid for the auction lot, an offsite bid indicator can be activated 418 by the offsite bidder (or a user authorized to bid on behalf of the offsite bidder) through activation a selector at a client terminal associated with the bidder. Following the activation 418 of the offsite bid indicator, a notification can be provided 420 to the auctioneer indicative of offsite bidding interest, as discussed above. As shown in this illustrated embodiment, the notification can be provided 420 to the auctioneer regardless of whether or not an offsite bid is actually submitted 410 by the offsite bidder who triggered the notification being provided 420.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. An auction system, comprising:
a first client terminal including a first display, a first memory storing first instructions, and a first processor configured to
execute the stored first instructions to cause first information regarding an auction lot available for live auction bidding to be shown on the first display,
receive a first signal indicative of a first input to the first client terminal, the first input being indicative of an interest of a first user to enter a bid on the auction lot, and
in response to the receipt of the first input, cause the first display to show second information allowing the first user to enter the bid on the auction lot; and
a second client terminal including a second processor, a second display, and a second memory storing second instructions, the second processor being configured to execute the stored second instructions to cause third information regarding the auction lot available for live auction bidding to be shown on the second display;
wherein the first processor is configured to, in response to the receipt of the first input, cause a second signal to be transmitted to the second client terminal; and
wherein the second processor is configured to, in response to the receipt of the second signal, cause a notification to be provided to a user of the second client terminal.

2. The system of claim 1, wherein the first processor is configured to cause the second signal to be transmitted to the second client terminal whether or not the first user enters the bid on the auction lot.

3. The system of claim 1, wherein the notification includes at least one of a visual notice shown on the second display, an audible sound provided through the second client terminal, and a haptic signal.

4. The system of claim 1, wherein the first processor is configured to receive a third signal indicative of a second input to the first client terminal, the second input being indicative of the user entering the bid on the auction lot; and
in response to the receipt of the third signal, the processor is configured to cause a fourth signal to be transmitted to the second client terminal that is indicative of the entered bid.

5. The system of claim 1, wherein the second processor is configured to cause a third signal to be transmitted from the second client terminal to the first client terminal, the third signal being indicative of the first information; and
the first processor is configured to, in response to receipt of the third signal at the first client terminal, cause the first information to be shown on the first display.

6. The system of claim 1, wherein the first client terminal includes an input/output device configured to receive the first input thereto and to transmit the first signal to the first processor.

7. The system of claim 1, further comprising a plurality of additional client terminals, each of the plurality of additional client terminals being configured to
cause information regarding the auction lot available for live auction bidding to be shown on a display associated with the client terminal,
receive a signal indicative of an input to the client terminal, the input being indicative of an interest of a user to enter a bid on the auction lot, and
in response to the receipt of the input, cause a signal to be transmitted to the second client terminal;
wherein the second processor is configured to, in response to the receipt of signal from the client terminal, cause a notification to be provided to the user of the second client terminal such that the user of the second client terminal can receive a plurality of notifications from any two or more of the first client terminal and the plurality of additional client terminals.

8. The system of claim 1, wherein the first client terminal includes a first network interface configured to facilitate electronic communication over a network, and the second client terminal includes a second network interface configured to facilitate electronic communication over the network.

9. The system of claim 1, wherein the first client terminal includes one of a desktop computer, a workstation, a minicomputer, a laptop computer, a tablet computer, a personal digital assistant (PDAs), a smart mobile phone, and a smart watch.

10. The system of claim 1, wherein the second client terminal includes one of a desktop computer, a workstation, a minicomputer, a laptop computer, a tablet computer, a personal digital assistant (PDAs), a smart mobile phone, and a smart watch.

11. An auction system, comprising:
a master client terminal including a display, a memory storing instructions, and a processor, the processor being configured to
execute the stored instructions to cause information regarding an auction lot available for live auction bidding to be shown on the display,
for each of a plurality of client terminals that are each remotely located from the master client terminal and that are each associated with a unique bidder, either receive no signal therefrom so as to indicate no interest in bidding on the auction lot from the bidder or receive a first signal therefrom so as to indicate interest in bidding on the auction lot from the bidder,
for each of the one or more of the plurality of client terminals that transmit the first signal to the master client terminal, either receive no follow-up signal therefrom so as to indicate no bid being placed by the bidder on the auction lot or receive a second signal therefrom so as to indicate a bid being placed by the bidder on the auction lot, and
in response to the receipt of each of the first signals, cause a notification to be provided to a user of the master client terminal.

12. The system of claim 11, wherein the master client terminal receives the first signal whether or not the bidder bids on the auction lot.

13. The system of claim 11, wherein the notification includes at least one of a visual notice shown on the display, an audible sound provided through the client terminal, and a haptic signal.

14. The system of claim 11, wherein the user of the master client terminal is an auctioneer.

15. The system of claim 11, wherein the master client terminal includes one of a desktop computer, a workstation, a minicomputer, a laptop computer, a tablet computer, a personal digital assistant (PDAs), a smart mobile phone, and a smart watch.

16. The system of claim 11, wherein the plurality of client terminals are each selected from the group consisting of a desktop computer, a workstation, a minicomputer, a laptop computer, a tablet computer, a personal digital assistant (PDAs), a smart mobile phone, and a smart watch.

17. An auction method, comprising:
causing information regarding an auction lot available for live auction bidding to be shown on a display of a master client terminal, the display being visually observable to an auctioneer of the live auction;
for each of a plurality of bidders that are each remotely located from the auctioneer, the master client terminal either (a) receiving no signal from a client terminal associated with the bidder so as to indicate no interest in bidding on the auction lot from the bidder or (b) receiving a first signal from the client terminal associated with the bidder so as to indicate interest in bidding on the auction lot from the bidder;
for each of the one or more of the client terminals that transmit the first signal to the master client terminal, either (c) receiving no follow-up signal from the client terminal associated with the bidder so as to indicate no bid being placed by the bidder on the auction lot or (d) receiving a second signal from the client terminal associated with the bidder so as to indicate a bid being placed by the bidder on the auction lot; and
in response to the receipt of each of the first signals, causing a notification to be provided to the auctioneer.

18. The method of claim 17, wherein the master client terminal receives the first signal whether or not the bidder bids on the auction lot.

19. The method of claim 17, wherein the notification includes at least one of a visual notice shown on the display, an audible sound provided through the client terminal, and a haptic signal.

20. The method of claim 17, wherein the master client terminal includes one of a desktop computer, a workstation, a minicomputer, a laptop computer, a tablet computer, a personal digital assistant (PDAs), a smart mobile phone, and a smart watch.
